(19) United States
(12) Patent Application Publication
(10) Pub. No.: US 2006/0108188 A1
(43) Pub. Date: May 25, 2006

(54) Friction brake lining for a disk brake, and brake caliper for such a friction brake lining

(75) Inventors: Dietmar Baumann, Hemmingen (DE); Dirk Hofmann, Ludwigsburg (DE); Herbert Vollert, Vaihingen/Enz (DE); Willi Nagel, Remseck/Hochdorf (DE); Andreas Henke, Diemelstadt (DE); Bertram Foitzik, Ludwigsburg (DE); Bernd Goetzelmann, Moeglingen (DE)

Correspondence Address: RONALD E. GREIGG;GREIGG & GREIGG P.L.L.C., 1423 POWHATAN STREET, UNIT ONE, ALEXANDRIA, VA, 22314, US

(73) Assignee: Robert Bosch GmbH

(21) Appl. No.: 11/269,694

(22) Filed: Nov. 9, 2005

(30) Foreign Application Priority Data
Nov. 9, 2004 (DE) 10 2004 054 012.8

(51) Int. Cl. F16D 65/04; F16D 69/00

(52) U.S. Cl. 188/250 G

(57) ABSTRACT

The invention relates to a friction brake lining having a lining holder for a disk brake in which the lining holder includes an encompassing rim and/or beads, which form a kind of reinforcing ribs and reinforce the lining holder against bending. The invention makes a thin and hence lightweight lining holder possible, which can be manufactured by deep drawings.

### CROSS-REFERENCE TO RELATED APPLICATIONS

This application is based on German Patent Application 10 2004 054 012.8 filed Nov. 9, 2004, upon which priority is claimed.

### BACKGROUND OF THE INVENTION

1. Field of the Invention

The invention is based on a friction brake lining for a disk brake and to a brake caliper for such a disk brake.

2. Description of the Prior Art

Friction brake linings of known disk brakes are mounted on platform-like, flat lining holders, which because of their thickness are resistant to bending.

### OBJECT AND SUMMARY OF THE INVENTION

The friction brake lining of the invention has a lining holder with one or more reinforcements against bending. The reinforcements may protrude from a lining holder plane in the manner of reinforcing ribs. The term reinforcements is understood to mean in particular stucture formed out from the lining holder plane, which because of their shape reinforce the lining holder against bending.

The invention has the advantage that it makes a thin and consequently lightweight lining holder possible, which is nevertheless resistant to bending.

Advantageous features and refinements of the invention are disclosed. For disassembly of the friction brake lining, one or more openings are provided for the engagement of a disassembly tool. As the disassembly tool, a screwdriver, for instance, can be put through the opening between the lining holder and the brake caliper, and the friction brake lining can be lifted from the brake caliper using the screwdriver.

The brake caliper of the invention has a friction brake lining with a lining holder of the type described above.

### BRIEF DESCRIPTION OF THE DRAWINGS

The invention will be better understood and further objects and advantages thereof will become more apparent from the ensuing detailed description of a preferred embodiment, taken in conjunction with the drawings, in which:

FIG. 1 is an exploded view in perspective of the friction brake linings of a disk brake according to the invention; and

FIG. 2 is a section taken along the angled line II-II in FIG. 1, on a different scale.

### DESCRIPTION OF THE PREFERRED EMBODIMENT

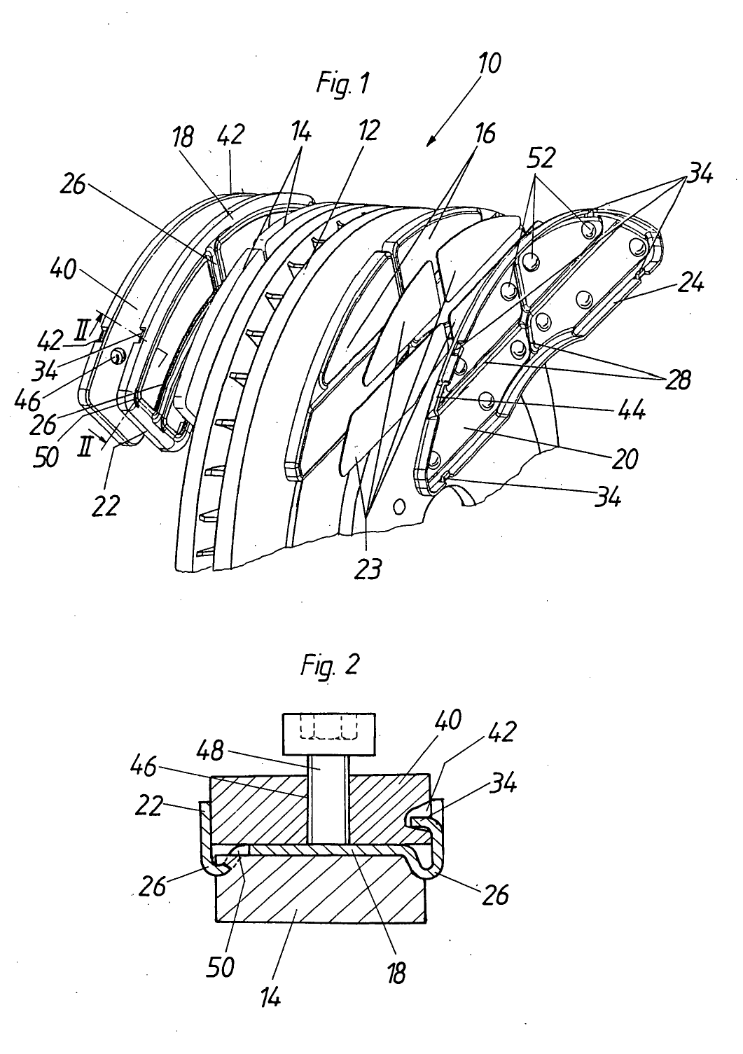

The disk brake 10 of the invention, shown in the drawings, has a brake disk 12 and two friction brake linings 14, 16, which are located facing one another on either side of the brake disk 12 in a brake caliper. The brake caliper itself is not shown, for the sake of clearly illustrating the other parts of the disk brake 10. The friction brake linings 14, 16 are in multiple parts and are mounted on lining holders 18, 20. Between the friction brake linings 14, 16 and the lining holders 18, 20, there can be an intermediate layer 23 for joining the friction brake linings 14, 16 to the lining holders 20. The intermediate layer 23 may be in multiple parts. In FIG. 1, a four-part intermediate layer 23 is shown between the friction brake lining 16 and the lining holder 20.

The multiple-part embodiment of the friction brake linings 14, 16 has the advantage that they can be more simply fastened to the lining holders 18, 20. For fastening to the lining holders 18, 20, it would be more favorable (not shown) to use small, compact friction brake linings that for instance are square or round. In the exemplary embodiment shown and described, friction brake linings 14, 16 in the form of an arc of a circle that are adapted to the circular shape of the brake disk 12 are used, as usual.

The lining holders 18, 20 are reformed parts, namely deep-drawn parts made of sheet metal. They have an encompassing rim 22, 24, which is reformed from the friction brake linings 14, 16 to protrude away from the lining holders 18, 20. Beads 26, 28 extending crosswise to one another form a kind of reinforcing ribs, which divide the lining holders 18, 20 into cassette-like indentations. The rims 22, 24 and the beads 26, 28 form reinforcements against bending of the lining holders 18, 20. They make it possible to manufacture the lining holders 18, 20 from thin material and to save weight. The rims 22, 24 and the beads 26, 28 furthermore bring about a form lock with the friction brake linings 14, 16 in a direction in which they are urged upon braking by a frictional force exerted on the friction brake linings 14, 16 by the brake disk 12. This improves the connection of the friction brake linings 14, 16 to the lining holders 18, 20.

On their rims, the lining holders 18, 20 have inward-oriented fastening tabs 34 for fastening in the brake caliper, not shown. When the friction brake linings 14, 16 are inserted into the brake caliper, the fastening tabs engage complementary recesses in the brake caliper from behind in the manner of a snap or detent device and by that means keep the brake linings 14, 16 in the brake caliper. The fastening tabs 34 can be embodied either resiliently or as plastically bendable, disposable bending tabs. In the first instance, when the friction brake linings 14 are fastened, the fastening tabs 34 snap elastically resiliently into the recesses in the brake caliper, and upon disassembly they snap back out again. In the latter instance, the fastening tabs are bent into the recesses in the brake caliper when the friction brake linings 14, 16 are being installed and must be bent back out again for disassembly. There is no provision for their being re-used.

The undercuts for engagement by the fastening tabs 34, besides being provided on the brake caliper itself, can also be provided on moving parts of the brake caliper, such as on a brake piston (not shown). In FIG. 1, it is contemplated that the friction brake lining 14 be fastened on a ramp plate 40 of a mechanical self-boosting device which has recesses 42 on its edges that form the undercuts for the engagement from behind by the fastening tabs 34. The ramp plate 40, on its back side, not visible in the drawing, that faces away from the friction brake lining 14, has ramps which extend circumferentially of the brake disk 12 and at an oblique angle to the plane of the brake disk. Via the ramps, the ramp plate 40 is braced circumferentially of the brake disk 12 and is movable obliquely to the brake disk plane (in the strict sense, the ramp plate is movable on a helical path that is coaxial to the brake disk 12) in the brake caliper, and as a result, by the so-called wedge principle, brings about brake boosting. This is known per se and, since it does not form the actual subject of the invention, will not be described further here. The resilient fastening tabs 34, which keep the friction brake linings 14, 16 in the brake caliper in the manner of snap connections, enable easy assembly and disassembly of the friction brake linings 14, 16 in the brake caliper.

The lining holders 18, 20 are arched in their longitudinal direction, or in other words in the secant direction of the brake disk 12; in their middle region, they have a greater spacing from the brake disk 12 than at their ends. The lining holders 18, 20 may also be embodied in concave or dishlike curved form. When the friction brake linings 14, 16 are being fastened in the brake caliper, the lining holders 18, 20 make contact first with their middle region, because of their curvature. At the edges, the lining holders 18, 20 must be pressed elastically against the brake caliper, so that the fastening tabs can be snapped or bent into the recesses in the brake caliper. The lining holders 18, 20 are thereby fastened in the brake caliper in prestressed fashion and hence do not rattle.

On the side of the friction brake linings 14, 16, the beads 26, 28 of the lining holders 18, 20 have openings 50, which form undercuts that are engaged from behind by the friction brake linings 14, 16. The friction brake linings 14, 16 are as a result held on the lining holders 18, 20 by positive engagement. A conventional material engagement of the friction brake linings 14, 16 and the lining holders 18, 20 can therefore be dispensed with, under some circumstances. In any case, the form-locking connection or positive engagement of the friction brake linings 14, 16 and the lining holders 18, 20 improves their connection to one another. Under some circumstances, the intermediate layers 23 may be dispensed with.

For disassembly of the friction brake linings, openings 44 are provided for the engagement of a disassembly tool. The openings 44 are disposed such that the disassembly tool can be introduced between the lining holders 18, 20 and the brake caliper, not shown, or the part of the brake caliper to which the lining holders 18, 20 are fastened. In the exemplary embodiment of the invention shown and described, an opening 44 for disassembly of the friction brake lining 16 is formed by an outward bulge of the rim 24 of the lining holder 20. The outward bulge makes it possible to introduce a screwdriver, as the disassembly tool, between the lining holder and the brake caliper; with the screwdriver, the lining holder 20 can easily be lifted along with the friction brake lining 16 from the brake caliper.

Another option for disassembly of the friction brake linings 14, 16 is shown in FIG. 2 for the friction brake lining 14. The ramp plate 40 is provided with one or more threaded holes 46, into which ejector screws 48 can be or are screwed. With the disassembly screws 48, the friction brake lining 14 can easily be lifted from the ramp plate 40 and thus released. The ejector screws 48 form a disassembly tool, and the threaded holes 46 form the openings for attaching the disassembly tool 48. Both disassembly options described simplify the release of the friction brake linings 14, 16 from the brake caliper and thus make it easier to change friction brake linings.

The lining holders 18, 20 have beads 52, distributed over their surface, which protrude from the sides of the lining holders that face away from the friction brake linings 14, 16. These beads 52 form spacers, which create a spacing between the brake caliper and the lining holders 18, 20. They reduce a heat transfer from the friction brake linings 14, 16 to the brake caliper via the lining holders 18, 20, and as a result the brake is protected against overheating. The term “beads 52” is understood to mean outward bulges or the like in the lining holders 18, 20 which reduce the contact of the lining holders 18, 20 in the brake caliper to point contact, linear contact, or small-area contact faces and thus lessen the heat transfer.

The foregoing relates to a preferred exemplary embodiment of the invention, it being understood that other variants and embodiments thereof are possible within the spirit and scope of the invention, the latter being defined by the appended claims.

We claim:

1. In a friction brake lining for a disk brake, in which the friction brake lining has a lining holder, the improvement wherein the lining holder comprises reinforcements against bending.

2. The friction brake lining in accordance with claim 1, wherein the reinforcements protrude from a lining holder plane in the manner of reinforcing ribs.

3. The friction brake lining in accordance with claim 2, wherein the lining holder comprises a rim, protruding from a lining holder plane, as a reinforcement against bending.

4. The friction brake lining in accordance with claim 2, wherein the lining holder comprises at least one bead as a reinforcement against bending.

5. The friction brake lining in accordance with claim 1, wherein the reinforcements form a form lock between the lining holder and the friction brake lining in a lining holder plane with the friction brake lining.

6. The friction brake lining in accordance with claim 1, wherein the lining holder is a reformed part.

7. The friction brake lining in accordance with claim 1, wherein that the friction brake lining is in multiple parts.

8. The friction brake lining in accordance with claim 1, wherein the lining holder comprises resilient fastening tabs for fastening in a brake caliper.

9. The friction brake lining in accordance with claim 1, wherein the lining holder comprises plastically bendable fastening tabs for fastening in a brake caliper.

10. The friction brake lining in accordance with claim 1, wherein the lining holder comprises an undercut, which undercut is engaged from behind by the friction brake lining.

11. The friction brake lining in accordance with claim 1, wherein the lining holder comprises beads as spacers, which beads protrude from a side of the lining holder facing away from the friction brake lining.

12. The friction brake lining in accordance with claim 1, wherein the lining holder is arched, and wherein a side facing away from the friction brake lining is convex.

13. A brake caliper for a disk brake having a friction brake lining with a lining holder, the lining holder having a reinforcement against bending, the improvement wherein the brake caliper and/or the lining holder comprises an opening for the engagement of a disassembly tool.

14. The brake caliper in accordance with claim 13, wherein the brake caliper comprises a threaded hole for screwing in an ejector screw, which ejector screw lifts the lining holder along with the friction brake lining from the brake caliper.
